(19) United States
(12) Patent Application Publication
(10) Pub. No.: US 2014/0352115 A1
(43) Pub. Date: Dec. 4, 2014

(54) DEVICE FOR HOLDING AT LEAST ONE LONGITUDINAL ELEMENT OF TUBE OR CABLE BUNDLE TYPE ON A SUPPORT

(71) Applicant: Amphenol- Air LB, Blagny (FR)

(72) Inventor: Laurent Devouge, Margut (FR)

(73) Assignee: Amphenol- Air LB, Blagny (FR)

(21) Appl. No.: 14/289,237

(22) Filed: May 28, 2014

(30) Foreign Application Priority Data
May 28, 2013 (FR) 1354794

(51) Int. Cl. F16G 11/02

(52) U.S. Cl. CPC F16G 11/02
USPC 24/129 W

(57) ABSTRACT

The present device for holding at least one longitudinal element of tube or cable bundle type on a support comprises a deformable collar (2) that is able to adopt an open position allowing the insertion of the longitudinal element and of the means (10, 11) for gripping the longitudinal element in the collar and for fixing the device onto the support.

The collar includes releasable means (17, 18) for temporarily immobilizing the collar in a closed position for holding the longitudinal element.

In general terms, the invention relates to cable collars and more particularly pertains to a device for holding a cable bundle or a tube on a support.

A particularly interesting application of a device of this type relates to the holding of a cable bundle or of a tube on the interior structure of an aircraft or in any other industrial field.

However, in general terms, the invention relates to the fixing of a bundle of longitudinal elements or of a tube on a structure.

As is known, in the field of aeronautical cables, a large number of collars are likely to be used for holding all the cable bundles of an aircraft instrument panel. The increased weight is one of the constant concerns for equipment manufacturers involved in the aeronautical field, and therefore this requirement also applies in the field of cable equipment and, in particular, collars for holding cable bundles.

In the prior art, devices for holding cable bundles were produced from a metal collar made from a curved tab in the form of an arc of a circle, enclosed in a silicone sleeve.

Production of the collar from a metal tab, although advantageous in terms of flexibility, presented a major drawback owing to its weight.

It was, furthermore, noted that the silicone sleeve had a tendency to slide along the collar and/or to slip transversely, which, on the one hand, made it less efficient in terms of its function of holding cables, and, on the other hand, was likely in the long term, to cause damage to the cable bundle.

It was proposed to offset this drawback and to use a collar for holding a cable bundle that was coated with a protective layer overmoulded along the inner face of the collar, and which comprised silicone. Reference may be made in this connection to document FR 2 969 274, which describes a collar of this type.

The object of the invention is to propose a device for holding a cable, the use of which is facilitated and which, in particular, may be positioned around a cable bundle prior to actual fixing to the support.

Thus, the subject of the invention is a device for holding at least one longitudinal element of tube or cable bundle type on a support, comprising a deformable collar that is able to adopt an open position allowing the insertion of the longitudinal element and of the means for gripping the longitudinal element in the collar and for fixing the device onto the support.

The collar further includes releasable means for temporarily immobilizing the collar in a closed position for holding the longitudinal element.

It has been observed that the provision of such releasable means for temporarily immobilizing the collar in the closed position made it possible to position collars relatively loosely on a longitudinal element prior to the actual gripping step for fixing the collars onto the support, which considerably facilitates their installation.

According to another feature of the holding device according to the invention, the collar includes a band of elastically deformable material that is able to adopt unstable open and closed positions and an unstable intermediate position.

Provision may thus be made for the releasable means for temporarily immobilising the collar to comprise a tooth provided at a first end zone of said band and on which a second end zone of the band comes to bear.

Thus, in the position of temporarily immobilisation of the collar in the closed position, the tooth comes to bear and is urged against the end zone of the band. By exerting a force on this end zone it is thus possible easily to release these immobilisation means in order, for example, to correct the installation of the collar on a cable bundle.

In one embodiment, the tooth includes a curved end pawl extending parallel to the general plane of the collar and engaging in a corresponding housing provided in the second end zone of the band.

Thus, in this case, the releasable immobilising means are released by exerting a force directed in the general plane of the collar, followed by lateral relative disengagement of the end zones of the collar.

In one embodiment, the means for gripping and fixing the device are arranged at the mutually opposite ends of the collar, each of which includes a tab provided with a hole.

The collar may be produced from thermoplastic material, a protective layer being overmoulded on the collar.

Advantageously, the protective-material layer includes silicone and extends along the inner face of the collar.

The collar itself may, for example, be produced from polyetheretherketone.

Advantageously, the protective layer is ribbed.

Lastly, provision may be made for the collar to include, at the location of the member for gripping and fixing the device, a thicker area and apertures located at the location of said fixing zone.

Further objects, features and advantages of the invention will become apparent upon reading the following description, which is given solely by way of non-limiting example, and which is given with reference to the appended drawings, in which:

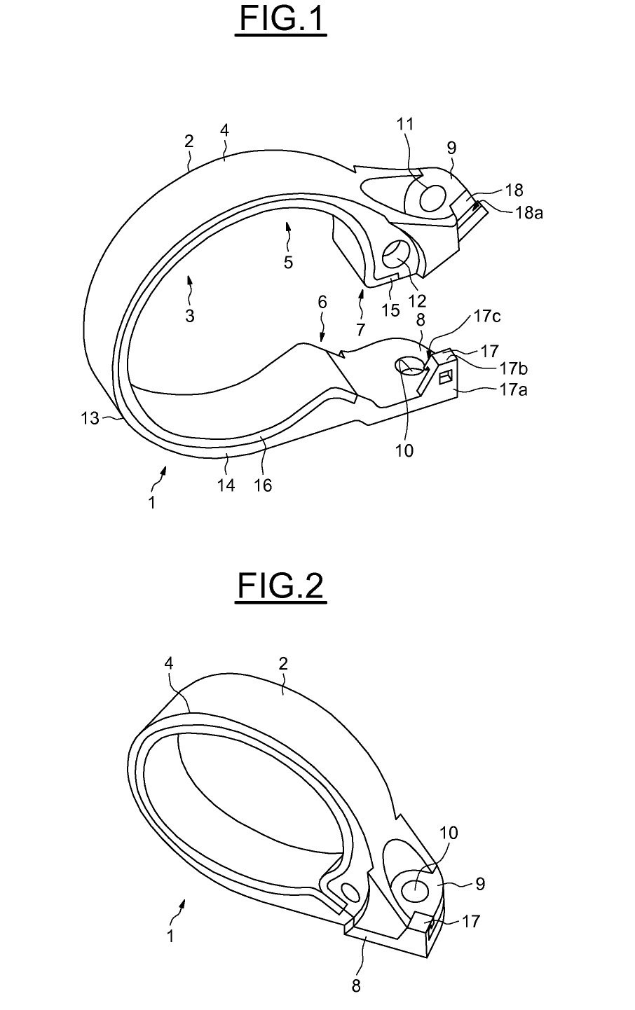

FIG. 1 illustrates a perspective view of a device for holding a cable bundle according to the invention;

FIG. 2 shows the device of FIG. 1 in the position of temporarily immobilising the collar in the closed position;

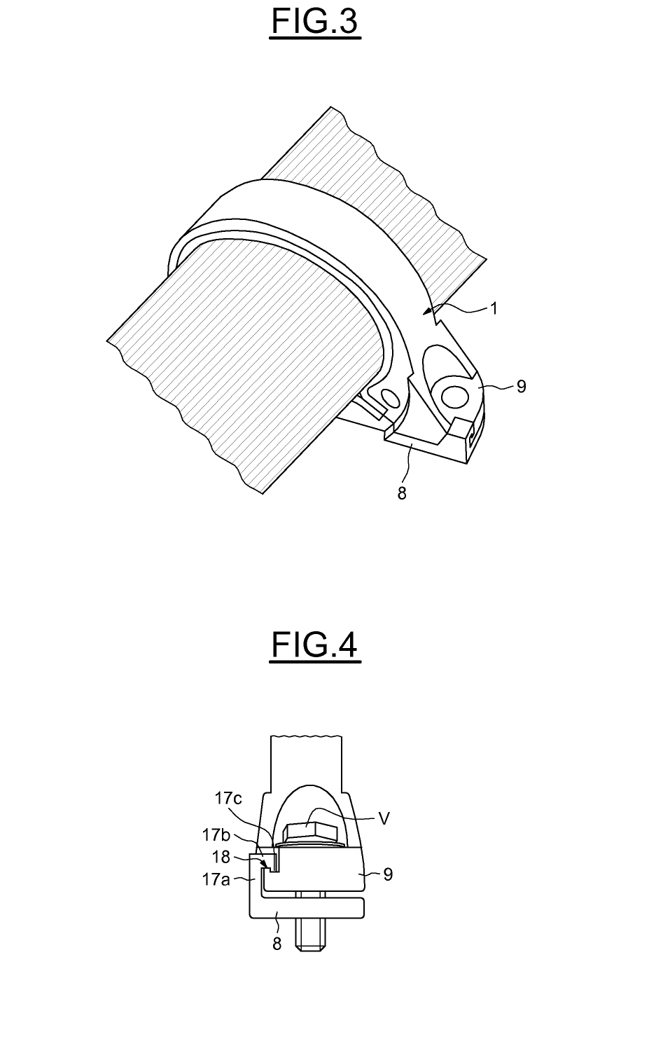

FIGS. 3, 4, 5, 6 and 7 are schematic diagrams illustrating the use of a device according to the invention;

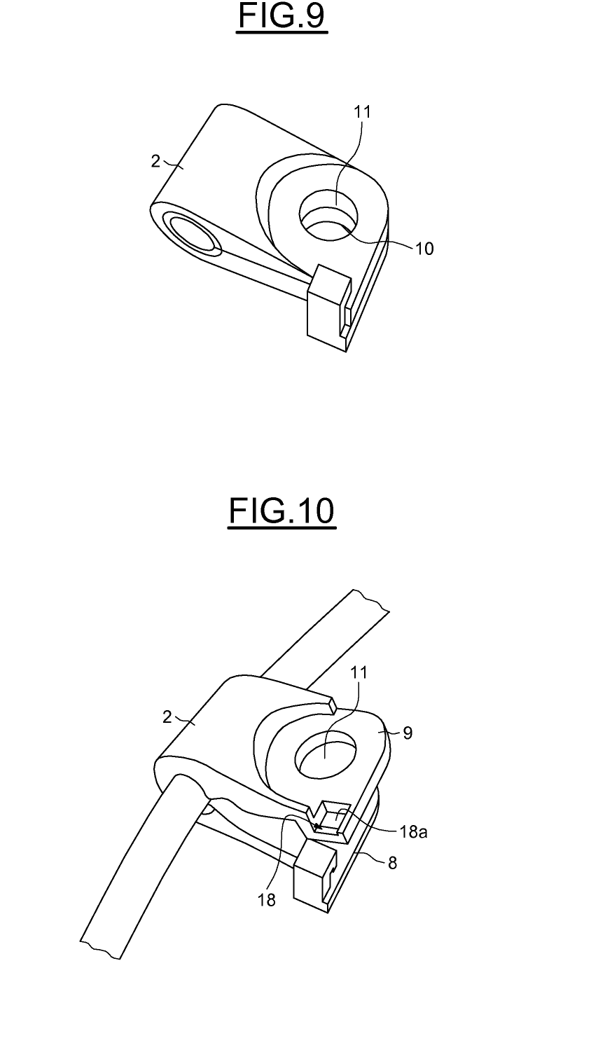

FIGS. 8 and 9 illustrate a further embodiment of a device for holding at least one longitudinal element according to the invention; and

FIGS. 10, 11 and 12 illustrate the use of the device of FIGS. 8 and 9.

A description will first be given of a first illustrative embodiment of a device for holding at least one longitudinal element according to the invention, with reference to FIGS. 1 to 7.

In the illustrative embodiment illustrated in said figures, the device, denoted by general numerical reference 1, is, here, designed for holding a cable strand on the interior structure of an aircraft. Nevertheless, it does not constitute a departure from the context of the invention for the device to be designed for fixing any other type of longitudinal element, in particular in the industrial field.

As will be seen, this device 1 is essentially constituted by a collar 2 comprising a band B of elastically deformable material and comprising a zone 3 that is partially annular, i.e. open, having a convex outer surface 4 and a concave inner surface 5 for actually holding the cable bundle. The facing ends 6 and 7 of the annular zone 3 are provided with means for tightening the cable bundle and for fixing the collar to a support (not shown in FIG. 1). The ends 6 and 7 thus extend in the form of tabs 8 and 9, each provided with a hole 10 and 11 designed to receive a fixing and tightening screw.

It will be noted that the collar 2 is produced as a single piece from injected thermoplastic material, for example from polyetheretherketone, which is also known as “PEEK”. A thermoplastic material of this type is relatively low in weight, when compared with materials of aluminium or stainless steel type used in the prior art. It is, furthermore, able to deform easily in order to resume its initial position, as may be seen in FIG. 1.

The collar 2 is thus able to be deformed between an open position, allowing the insertion of cables, and a closed position for holding cables on the structures. It will be noted that, preferably, by virtue of the production of the collar from PEEK, said collar is able to adopt a totally open, substantially flat position, allowing easy positioning of the strand, whilst returning to its original position as illustrated in FIG. 1. By selecting a collar of appropriate dimensions, in this position the strand may be held prior to closure of the collar, by virtue of an elastic force then exerted on the strand. However, as will be described in detail below, use will advantageously be made of means for temporarily immobilizing the collar in a closed position for holding the strand.

The collar may then be closed, either by applying the end tabs over one another and by fixing them to the structure, for example with the aid of a screw, or by using another fixing system.

It will be noted, in this connection, that one of the tabs, i.e. the tab denoted by reference 8, extends laterally relative to the corresponding end of the annular part, whist the other tab, i.e. the tab referenced 9, extends in the extension of the opposite end of the annular part in such a manner that, in the closed position of the collar, the two tabs engage, one against the other.

In order to affect assembly and to increase the stiffness of the collar, in the joining zone between the annular part and the end tabs the collar has a thicker area to prevent any risk of a cable of the strand being pinched between the end tabs 8 and 9 when the device is closed. However, provision will be made for apertures, such as 12, located in this joining zone, with a view to reducing the weight of the assembly.

The device 1 is also provided with a protective layer 14 covering the concave face of the collar 2 and extending along a substantial part of the end tabs 8 and 9, for example as far as the holes 10 and 11.

Provision will thus be made for, for example, an impression 15 along that face of the collar that is designed to receive this protective layer.

Whilst the collar 2 is made from thermoplastic material, the protective layer 14 is made from silicone. “Silicone” is understood to mean, in this case, a silicone-based polymer. The use of silicone makes it possible, by virtue of its elastic properties, to achieve effective holding of the strand. Furthermore, the presence of this silicone layer at the location of the tabs makes it possible to avoid any risk of damage to the cables in the event of pinching when the device is closed.

With a view to obtaining satisfactory cohesion between the silicone and the collar 2, the silicone-based protective layer is produced by overmoulding which makes it possible to avoid any risk of the protective layer shifting.

It has been observed that the combined use of a collar made from thermoplastic material and of an overmoulded silicone protective layer made it possible to obtain a relatively significant weight advantage of the order of 50% as compared with the prior art. Indeed, it was noted that a collar designed for holding a cable bundle of 42 mm diameter had a weight of the order of 10.5 g.

Lastly, it will noted that, with a view to facilitating holding of the cable bundle without immobilizing the latter, provision will be made for longitudinal ribs, such as 16, provided in the protective layer 14 at the time of overmoulding.

It will furthermore be noted that, as indicated previously, the collar 2 is made from an elastically deformable material that is able to adopt a stable, partially open position, which can be seen in FIG. 1, and unstable open and closed positions.

The device is, moreover, provided with releasable means for temporarily immobilizing the collar in a closed position for holding the cable bundle.

This involves, in particular, being able to immobilize the collar temporarily in a position for holding a cable bundle, in which the holes 10 and 11 extend substantially coaxially, so as to allow the easy insertion of a screw for fixing and tightening the device.

As is seen in FIG. 1, these immobilizing means take the form of a tab 17 constituting a tooth provided at one of the ends of the collar, on which the opposite end of the collar is intended to come to bear in the closed position for holding the cable bundle.

More particularly, the end of the collar opposite the tooth 17 includes an impression 18 designed to receive the tooth 17.

As is seen, the tooth 17 has a general L shape and includes a first branch 17a rising from the end tab 8 and a branch 17b extending perpendicularly to the first branch 17a.

Advantageously, provision will be made to provide the second branch 17b with a curved pawl 17c extending parallel to the first branch 17a and accommodated in a corresponding housing 18a of the impression provided in the opposite end of the collar 2 (FIG. 8).

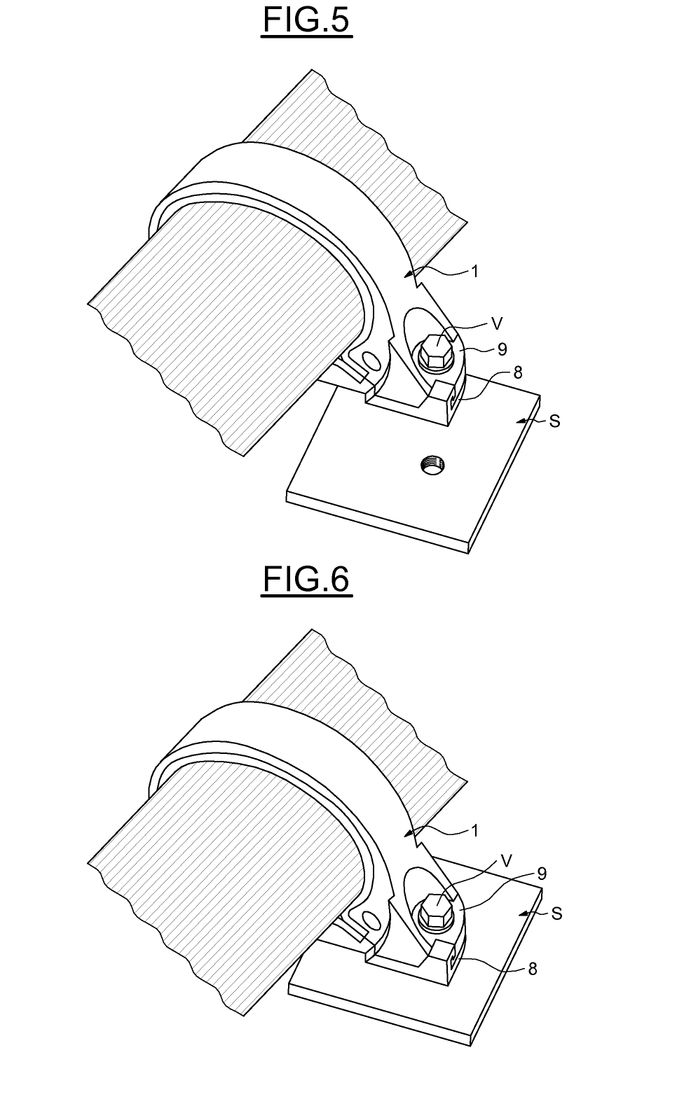

Thus, with reference to FIG. 2, on the basis of the position shown in FIG. 1, it is possible, by bringing the tabs 8 and 9 closer together and by engaging the tooth 17 in the housing 18, to achieve temporary locking of the device 1 on a cable bundle (FIGS. 2 and 3). As indicated previously, in this position the holes 10 and 11 are aligned such that it is easily possible to insert a screw V combined, if appropriate, with a washer (FIGS. 4 and 5) in order then to tighten and to screw the device onto a support S (FIG. 6).

It will, nevertheless, be noted that, in the temporary immobilisation position, it is still possible to adjust the position of the device on the strand and even, if appropriate, to open the collar by disengaging the tooth 17 from the housing 18.

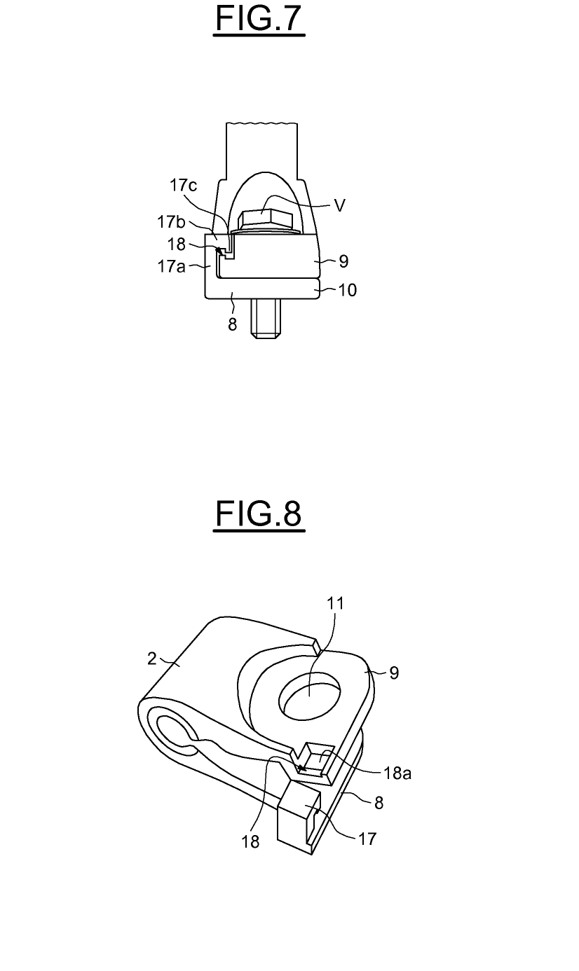

It will, nevertheless, be noted that when the tooth 17 includes a curved pawl 17c, as described previously, disengagement is achieved, on the one hand, by exerting a force on the tabs (FIG. 7) and then by laterally disengaging the tabs 8 and 9 in order to release the tooth 17.

It will be noted that the invention is not limited to the embodiments described above, the device comprising the collar provided with means for gripping and for fixing the device on the support and releasable means for temporarily immobilizing the collar potentially having a variety of configurations.

Indeed, as may be seen in FIGS. 8, 9, 10, 11 and 12, the device may include a collar of a size appropriate to the number of cables in the bundle to be positioned in relation to a support.

As can be seen from these figures, in which elements that are identical to those in FIGS. 1 to 7 bear the same numerical references, it can be seen that the device also includes tabs 8 and 9 provided with holes 10 and 11 and also a tooth 17 engaging in a housing 18.

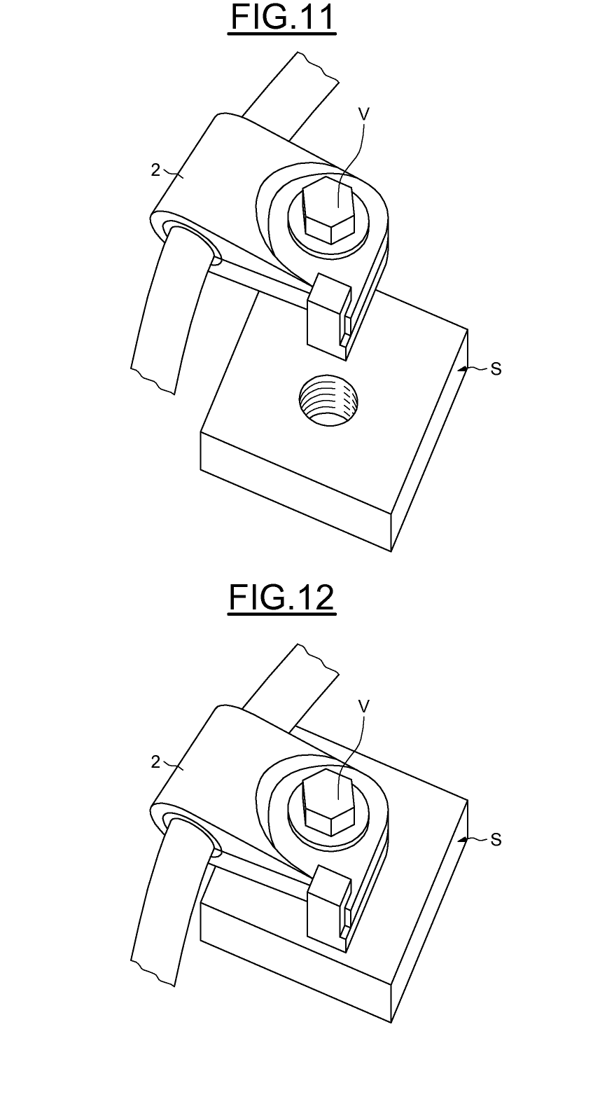

As indicated previously, this device is used by inserting a cable bundle in the collar (FIG. 10) then by temporarily immobilizing the collar in a closed position for holding the cables by engaging the tooth 17 in the housing 18 (FIG. 11). In this position, a screw V may be inserted in the holes 10 and 11 in order to grip and to fix the device on a support S.

1. Device for holding at least one longitudinal element of tube or cable bundle type on a support, comprising a deformable collar (2) that is able to adopt an open position allowing the insertion of the longitudinal element and of the means (10, 11) for gripping the longitudinal element in the collar and for fixing the device onto the support, characterized in that the collar (2) includes releasable means (17, 18) for temporarily immobilizing the collar in a closed position for holding the longitudinal element.

2. Device according to claim 1, characterized in that the collar includes a band (B) of elastically deformable material that is able to adopt unstable open and closed positions and an unstable intermediate position.

3. Device according to claim 2, characterized in that the releasable means for temporarily immobilising the collar comprise a tooth (17) provided at a first end zone of said band and on which a second end zone of the band comes to bear.

4. Device according to claim 3, characterized in that the tooth (17) includes a curved end pawl (17c) extending parallel to the general plane of the collar and engaging in a corresponding housing (18) provided in the second end zone of the band.

5. Device according to any one of claims 1 to 4, characterized in that the means for gripping and fixing the device are arranged at the mutually opposite ends of the collar, each of which includes a tab (8, 9) provided with a hole (10, 11).

6. Device according to any one of claims 1 to 5, characterized in that the collar is produced from thermoplastic material, a protective layer being overmoulded on the collar.

7. Device according to claim 6, characterized in that the protective-material layer includes silicone and extends along the inner face of the collar.

8. Device according to one of claims 6 and 7, characterized in that the collar is produced from polyetheretherketone.

9. Device according to any one of claims 6 to 8, characterized in that the protective layer is ribbed.

10. Device according to any one of claims 1 to 9, characterized in that the collar includes, at the location of the member for gripping and fixing the device, a thicker area and apertures (12) located at the location of said joining zone.
